(19) United States
(12) Patent Application Publication
(10) Pub. No.: US 2019/0340395 A1
(43) Pub. Date: Nov. 7, 2019

(54) CARD READER DEVICE

(71) Applicant: HITACHI-OMRON TERMINAL SOLUTIONS, CORP., Tokyo (JP)

(72) Inventors: Hiroyuki SUZUKI, Tokyo (JP); Tomoya KIMURA, Tokyo (JP); Kenichi MASADA, Tokyo (JP); Akihiro TADAMASA, Tokyo (JP)

(73) Assignee: HITACHI-OMRON TERMINAL SOLUTIONS, CORP., Tokyo (JP)

(21) Appl. No.: 16/234,520

(22) Filed: Dec. 27, 2018

(30) Foreign Application Priority Data
May 7, 2018 (JP) 2018-089354

(51) Int. Cl. G06K 7/08

(52) U.S. Cl. CPC G06K 7/087

(57) ABSTRACT

A card reader device A1 includes: a housing 11; an openable shutter 311 that allows or disallows passing of a magnetic card C into the housing 11; a magnetic head 511 that reads magnetic data of the magnetic card C received in the housing 11; an interfering magnetic field generator 711 provided on a rear surface side of the shutter 311 to generate an interfering magnetic field in at least a region R between the magnetic head 511 and the shutter 311; an interfering magnetic field control unit 61 that controls generation of the interfering magnetic field; and an interfering magnetic field alleviating unit 81 that alleviates an influence of the interfering magnetic field on the magnetic head 511 so that the interfering magnetic field generated by the interfering magnetic field generator 711 does not interfere the reading of the magnetic data by the magnetic head 511.

### BACKGROUND

The present invention relates to a card reader device.

As an example of a method of illegally acquiring information on magnetic cards used in a transaction processing device such as an automatic teller machine (ATM), a method of installing a magnetic head for illegally acquiring magnetic data in a transaction processing device or the like and acquiring magnetic data of magnetic cards using the magnetic head (skimming) is known.

In such a method, since the magnetic head is generally provided to cover a magnetic card insertion opening of a transaction processing device or the like, illegal reading of magnetic data is prevented by generating an interfering magnetic field near the insertion opening.

On the other hand, in recent years, a method of inserting a thin skimmer to which a small magnetic head is attached into the inner side of an insertion opening to acquire magnetic data while avoiding an insertion opening in order to avoid an interfering magnetic field near the insertion opening has been used.

As a countermeasure against such a new method, a technology of detecting a skimming device inside a card reader, for example, is disclosed (for example, see Japanese Patent Application Publication No. 2017-219971).

According to this technology, since a capacitive sensor can detect attachment of a skimming device and a predetermined alarm is output when attachment of the device is detected, it is possible to prevent reading of magnetic data.

### SUMMARY

However, since the conventional method described above merely detects attachment of a skimming device and outputs an alarm, the method does not directly prevent reading of magnetic data, and there is a concern that the magnetic data may be read if the skimming device is attached forcibly.

On the other hand, a method of providing an interfering magnetic field generator in a card reader device to generate an interfering magnetic field in the card reader device may be used. However, if an interfering magnetic field is generated, the interfering magnetic field may have an influence on reading of magnetic data by a proper magnetic head and may interfere correct reading.

The present invention has been made based on the above-described problems, and an object thereof is to provide a card reader device capable of preventing a skimmer from reading magnetic data using an interfering magnetic field without interfering the reading of magnetic data by a proper magnetic head, even when the skimmer is inserted therein.

In order to solve the problems, the present invention provides a card reader device including: a housing; an openable shutter provided in the housing to allow or disallow passing of a magnetic card into the housing; a magnetic head provided in the housing to read magnetic data of the magnetic card received in the housing; an interfering magnetic field generator provided on a rear surface side of the shutter to generate an interfering magnetic field in at least a region between the magnetic head and the shutter; an interfering magnetic field control unit that controls generation of the interfering magnetic field by the interfering magnetic field generator; and an interfering magnetic field alleviating unit that alleviates an influence of the interfering magnetic field on the magnetic head so that the interfering magnetic field generated by the interfering magnetic field generator does not interfere the reading of the magnetic data by the magnetic head.

In the present specification, the “rear surface side” means a horizontal direction in which a proper magnetic head is present in relation to a position where the shutter is provided. The proper magnetic head indicates a magnetic head for reading magnetic data, properly provided inside the housing.

The present invention can provide a card reader device capable of preventing a skimmer from reading magnetic data using an interfering magnetic field without interfering the reading of magnetic data by a proper magnetic head, even when the skimmer is inserted therein.

### BRIEF DESCRIPTION OF THE DRAWINGS

FIG. 1 is a schematic cross-sectional view illustrating a first embodiment of the present invention;

FIG. 2 is a schematic block diagram of FIG. 1;

FIG. 3 is a schematic cross-sectional view illustrating an operation state of FIG. 1;

FIGS. 4A and 4B are schematic diagrams illustrating an example of a waveform in FIG. 2, in which FIG. 4A illustrates a waveform of an interfering magnetic field and FIG. 4B illustrates a waveform of a magnetic card;

FIG. 5 is a schematic diagram illustrating another example of an interfering waveform in FIG. 2;

FIG. 6 is a schematic cross-sectional view illustrating a second embodiment of the present invention;

FIG. 7 is a schematic block diagram of FIG. 6;

FIGS. 8A to 8E are schematic diagrams illustrating reading timings and waveforms of the second embodiment, in which FIG. 8A illustrates a magnetic card detection timing, FIG. 8B illustrates a waveform of an interfering magnetic field, FIG. 8C illustrates a reading waveform of a proper magnetic head, FIG. 8D illustrates a reading timing of a skimmer magnetic head, and FIG. 8E illustrates a reading waveform of a skimmer magnetic head;

FIG. 9 is a schematic cross-sectional view illustrating a third embodiment of the present invention;

FIG. 10 is a schematic block diagram of FIG. 9; and

FIG. 11 is a schematic cross-sectional view illustrating an operation state of FIG. 9.

### DETAILED DESCRIPTION OF THE EMBODIMENT

The card reader device includes: a housing; an openable shutter provided in the housing to allow or disallow passing of a magnetic card into the housing; a magnetic head provided in the housing to read magnetic data of the magnetic card received in the housing; an interfering magnetic field generator provided on a rear surface side of the shutter to generate an interfering magnetic field in at least a region between the magnetic head and the shutter; an interfering magnetic field control unit that controls generation of the interfering magnetic field by the interfering magnetic field generator; and an interfering magnetic field alleviating unit that alleviates an influence of the interfering magnetic field on the magnetic head so that the interfering magnetic field generated by the interfering magnetic field generator does not interfere the magnetic head reading the magnetic data.

In the present specification, a “front surface side” means a horizontal direction opposite to the rear surface side.

Hereinafter, the first to third embodiments of the present invention will be described with reference to the drawings, and the present invention is not limited to the embodiments described in the drawings.

### First Embodiment

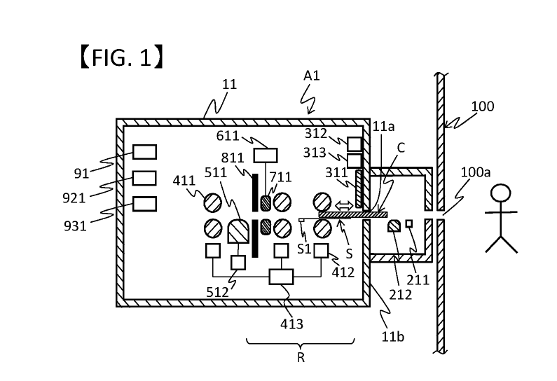

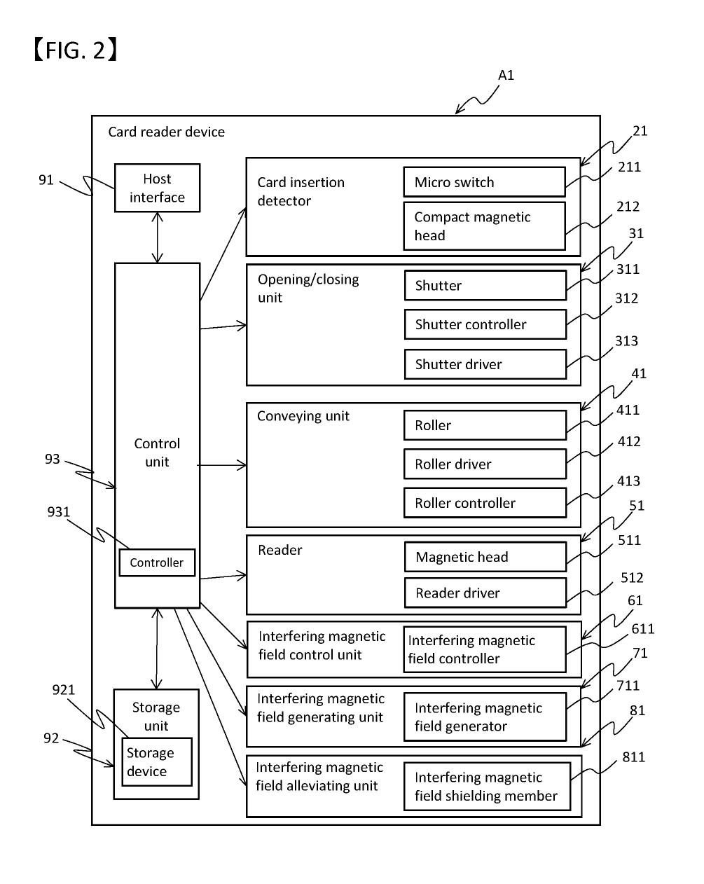

FIG. 1 is a schematic cross-sectional view illustrating a first embodiment of the present invention. FIG. 2 is a schematic block diagram of FIG. 1. The card reader device is mounted on a transaction processing device such as an ATM provided in a banking institution, for example, and reads magnetic data recorded on magnetic cards possessed by customers. As illustrated in FIGS. 1 and 2, a card reader device A1 schematically includes a housing 11, a card insertion detector 21, an opening/closing unit 31, a conveying unit 41, a reader 51, an interfering magnetic field control unit 61, an interfering magnetic field generating unit 71, an interfering magnetic field alleviating unit 81, a host interface 91, a storage unit 92, and a control unit 93.

The housing 11 accommodates a magnetic head 511 of the reader 51 to be described later. The housing 11 has an opening 11a which is formed in a portion of a wall 11b to and from which a magnetic card C can be inserted and detached, and an approximately closed space is formed in the housing when a shutter 311 of the opening/closing unit 31 is closed. The housing 11 is disposed in the transaction processing device 100, for example, and an opening 11a of the housing 11 is connected to an insertion opening 100a of the transaction processing device 100 through which a user inserts the magnetic card C.

The card insertion detector 21 detects whether the magnetic card C is inserted through the insertion opening 100a of the transaction processing device 100 and whether the inserted magnetic card C is a magnetic card readable by the card reader device A1. The card insertion detector 21 has a micro switch 211 and a compact magnetic head 212. When the magnetic card C is inserted and the micro switch 211 operates, the compact magnetic head 212 reads the magnetic data of the magnetic card C. When it is determined that the magnetic card C is a readable magnetic card, the magnetic card C is conveyed to a side deeper than a shutter 311 to be described later inside the housing 11. When it is determined that the magnetic card C is not a readable magnetic card, the magnetic card C is conveyed back to the insertion opening 100a.

The opening/closing unit 31 allows or disallows passing of the magnetic card C into the housing 11. The opening/closing unit 31 is provided in the opening 11a of the housing 11, for example, and includes, for example, an openable shutter 311 that restricts entry of the magnetic card C into the card reader device A1, a shutter controller 312 that controls opening/closing of the shutter 311, and a shutter driver 313 (a solenoid or the like) that drives opening/closing of the shutter 311 on the basis of an instruction from the shutter controller 312.

The conveying unit 41 conveys the magnetic card C inserted into the housing 11 to a predetermined position. The conveying unit 41 includes, for example, a plurality of rollers 411 for conveying the magnetic card C, a roller driver 412 (a motor or the like) for rotating the roller 411, and a roller controller 413 that controls driving of the roller driver 412. The magnetic card C is pinched between a pair of facing rollers 411 and the rollers 411 are rotated by the roller driver 412, whereby the magnetic card C is conveyed in a reciprocating manner.

The reader 51 reads the magnetic data of the magnetic card C received in the housing 11. The reader 51 includes, for example, a proper magnetic head 511 for reading magnetic data provided properly in the housing 11 and a reader driver 512 for driving the magnetic head 511. When the magnetic card C passes through a reading position of the magnetic head 511, the magnetic head 511 reads magnetic data recorded on a magnetic tape of the magnetic card C.

The interfering magnetic field control unit 61 controls generation of an interfering magnetic field by an interfering magnetic field generator 711 to be described later. Specifically, the interfering magnetic field control unit 61 includes an interfering magnetic field controller 611, for example, and the interfering magnetic field controller 611 instructs the interfering magnetic field generator 711 to generate an interfering magnetic field and stop generating the interfering magnetic field. Moreover, the interfering magnetic field control unit 61 may control the waveform of the interfering magnetic field. The interfering magnetic field control unit 61 of the present embodiment controls the interfering magnetic field generator 711 so that an interfering magnetic field of a predetermined waveform is generated constantly at least while the magnetic head 511 is reading the magnetic data.

The interfering magnetic field generating unit 71 generates an interfering magnetic field at least in a region (hereinafter also referred to as a “region R”) between the magnetic head 511 and the shutter 311. The interfering magnetic field generating unit 71 may include the interfering magnetic field generator 711 provided on the rear surface side of the shutter 311 to generate an interfering magnetic field and a driving circuit for driving the interfering magnetic field generator 711, for example. In the present embodiment, a coil antenna is used as the interfering magnetic field generator 711, and the coil antenna is disposed between the shutter 311 and the magnetic head 511 in the housing 11. A current flows into the coil antenna whereby an interfering magnetic field is generated (radiated). In this way, the card reader device A1 can be formed more integrally.

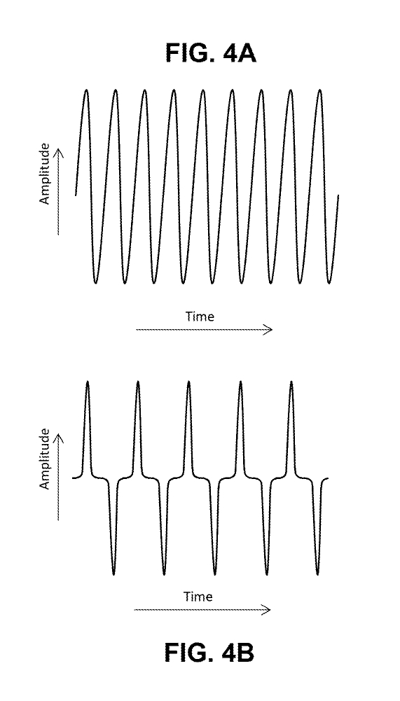

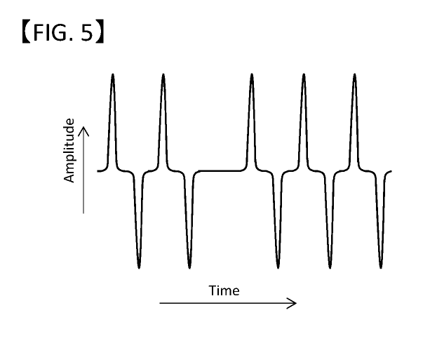

The waveform of the interfering magnetic field generated by the interfering magnetic field generator 711 may be completely different from the waveform of magnetic data (see FIG. 4A) and may be a waveform that simulates the waveform of magnetic data (see FIG. 5). The interfering magnetic field generator 711 preferably generates an interfering magnetic field having a waveform that simulates the waveform of magnetic data of the magnetic card C. A skimmer S generally reads magnetic signals constantly and stores the read magnetic signals in a storage device (not illustrated) of the skimmer S, and the magnetic signals stored in the storage device may be analyzed after the skimmer S is collected. In this case, for example, signals having obviously different waveforms are determined as originating from an interfering magnetic field, and one tries to reconstruct magnetic data by removing the signals. Therefore, as described above, by generating an interfering magnetic field that simulates the magnetic data, it is possible to disturb reading of the magnetic data by the skimmer S and to prevent the skimmer S from reading the magnetic data more reliably.

The interfering magnetic field alleviating unit 81 alleviates the influence of an interfering magnetic field on the magnetic head 511 so that the interfering magnetic field generated by the interfering magnetic field generator 711 does not interfere the reading of the magnetic data by the magnetic head 511. In the present embodiment, the interfering magnetic field alleviating unit 81 is a shield-shaped interfering magnetic field shielding member 811 disposed between the interfering magnetic field generator 711 and the magnetic head 511 to shield the interfering magnetic field. The interfering magnetic field alleviating unit 81 is disposed at a position at which the magnetic head 511 is magnetically concealed from the interfering magnetic field generator 711 (a position at which the influence of an interfering magnetic field from the interfering magnetic field generator 711 is negligible). Examples of a material that forms such an interfering magnetic field shielding member 811 includes a magnetic material such as an electrical steel.

Since the interfering magnetic field alleviating unit 81 is the interfering magnetic field shielding member 811, the interfering magnetic field generated by the interfering magnetic field generator 711 has directivity, and the magnetic head 511 can read the magnetic data correctly due to alleviation of the influence of the interfering magnetic field on the magnetic head 511.

The host interface 91 transmits and receives information (magnetic data) of the magnetic card C read by the card reader device A1 between the card reader device A1 and the main body of the transaction processing device 100. The storage unit 92 stores various pieces of information with the aid of a storage device 921. The control unit 93 controls operations of the respective units of the interfering magnetic field generating unit 71 with the aid of a controller 931.

The functions performed by the card insertion detector 21, the opening/closing unit 31, the conveying unit 41, the reader 51, the interfering magnetic field control unit 61, and the like can be realized (controlled) by operating a predetermined computer program on hardware using hardware components (not illustrated) including a central processing unit (CPU), a memory, a storage device, and a bus that connects these components, for example.

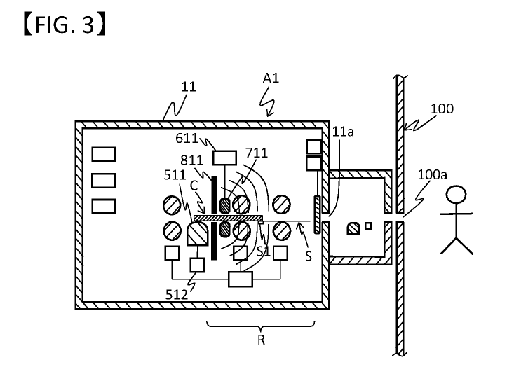

Next, an operation mode of the card reader device A1 will be described. When a user inserts the magnetic card C from the insertion opening 100a of the transaction processing device 100, the micro switch 211 of the card insertion detector 21 operates and the compact magnetic head 212 reads the magnetic data of the magnetic card C. In this case, when the card insertion detector 21 determines that the magnetic card C is not a readable magnetic card, the magnetic card C is conveyed back to the insertion opening 100a. When the card insertion detector 21 determines that the magnetic card C is a readable magnetic card, the magnetic card C is conveyed to a side deeper than the shutter 311 inside the housing 11 and the shutter 311 is closed. Subsequently, as illustrated in FIG. 3, an interfering magnetic field is generated from the interfering magnetic field generator 711 according to an instruction from the interfering magnetic field control unit 61 (FIG. 3 schematically illustrates the interfering magnetic field). The interfering magnetic field generator 711 may generate the interfering magnetic field constantly regardless of whether the magnetic card C is inserted or not.

Subsequently, when the magnetic card C reaches the reading position of the magnetic head 511, the magnetic head 511 reads the magnetic data stored in the magnetic card C. In this case, on the front surface side of the interfering magnetic field shielding member 811, the magnetic field is disturbed due to coexistence of the interfering magnetic field and the signal of the magnetic data generated from the magnetic card C. Therefore, it is difficult to reconstruct original magnetic data from the waveform read by the magnetic head S1 of the skimmer S placed therein. As a result, reconstruction of the magnetic data using the skimmer S is prevented. On the other hand, on the rear surface side of the interfering magnetic field shielding member 811, since the interfering magnetic field is shielded by the interfering magnetic field shielding member 811, the influence of the interfering magnetic field is suppressed, and a correct waveform of the magnetic data can be read by the magnetic head 511.

As described above, since the card reader device A1 has the above-described configuration, even if the skimmer S is inserted inside the card reader device A1, it is possible to prevent the skimmer S from reading the magnetic data using the interfering magnetic field without interfering the reading of the magnetic data by the proper magnetic head 511.

### Second Embodiment

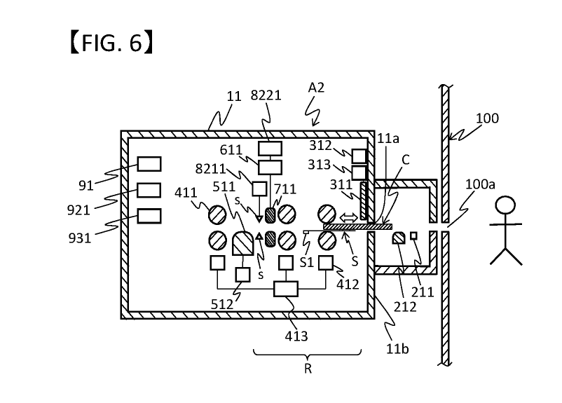

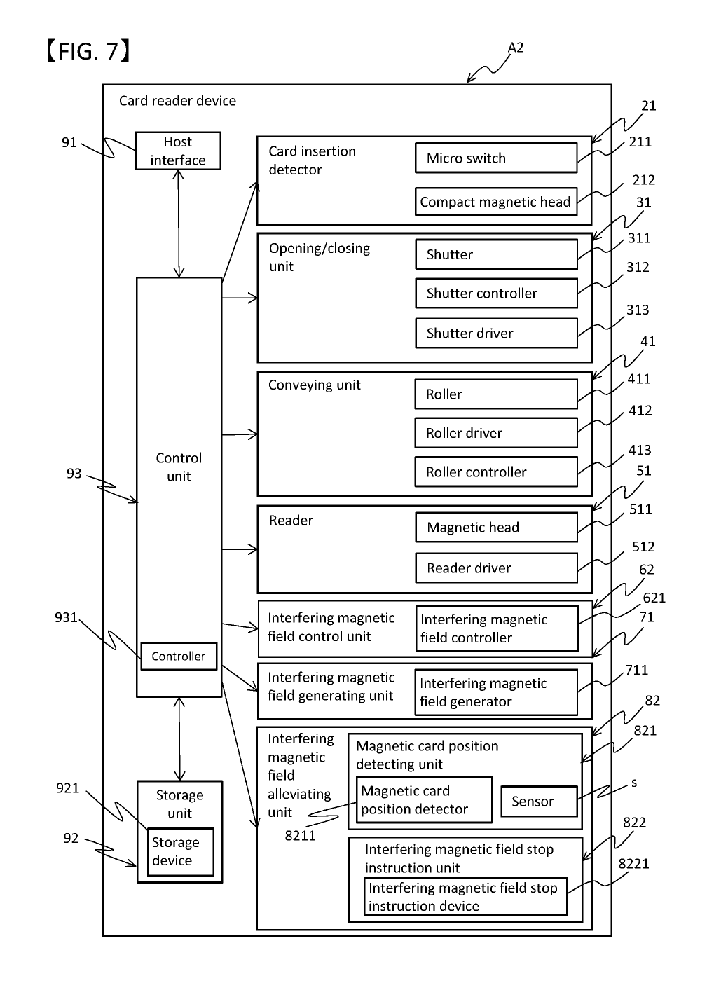

FIG. 6 is a schematic cross-sectional view illustrating a second embodiment of the present invention. FIG. 7 is a schematic block diagram of FIG. 6. As illustrated in FIGS. 6 and 7, a card reader device A2 schematically includes a housing 11, a card insertion detector 21, an opening/closing unit 31, a conveying unit 41, a reader 51, an interfering magnetic field control unit 62, an interfering magnetic field generating unit 71, an interfering magnetic field alleviating unit 82, a host interface 91, a storage unit 92, and a control unit 93. The card reader device A2 is different from the configuration of the first embodiment in that the device A2 includes the interfering magnetic field control unit 62 and the interfering magnetic field alleviating unit 82. The other configuration is similar to that of the first embodiment, and the same portions will be denoted by the same reference numerals and the detailed description thereof will be omitted.

The interfering magnetic field control unit 62 controls generation of an interfering magnetic field by the interfering magnetic field generator 711. The interfering magnetic field control unit 62 of the present embodiment is configured as an interfering magnetic field controller 621. The interfering magnetic field controller 621 stops generation of the interfering magnetic field by the interfering magnetic field generator 711 for a predetermined period on the basis of an instruction from an interfering magnetic field stop instruction unit 822 of the interfering magnetic field alleviating unit 82 to be described later. The predetermined period includes at least a period in which the magnetic head 511 reads the magnetic data of the magnetic card C.

The interfering magnetic field alleviating unit 82 alleviates the influence of an interfering magnetic field on the magnetic head 511 so that the interfering magnetic field generated by the interfering magnetic field generator 711 does not interfere the reading of the magnetic data by the magnetic head 511. In the present embodiment, the interfering magnetic field alleviating unit 82 includes a magnetic card position detecting unit 821 and an interfering magnetic field stop instruction unit 822.

The magnetic card position detecting unit 821 detects whether the magnetic card C is at a position at which the magnetic data is read by the magnetic head 511. Specifically, the magnetic card position detecting unit 821 is configured as a magnetic card position detector 8211 in which a plurality of sensors s such as an optical sensor are arranged in respective portions of the conveying path of the magnetic card C in the card reader device A2. The magnetic card position detector 8211 specifies the position of the magnetic card C in the card reader device A2 on the basis of the output of the respective sensors s. The arrangement of the sensors s is not particularly limited as long as it is possible to detect a timing at which the magnetic head 511 reads the magnetic data, and the sensors s may be disposed on the front surface side and/or the rear surface side of the magnetic head 511.

When the magnetic card position detecting unit 821 detects that the magnetic card C is at the position (reading position) at which the magnetic data is read, the interfering magnetic field stop instruction unit 822 instructs the interfering magnetic field control unit 62 so that the interfering magnetic field generator 711 stops generating the interfering magnetic field. In the present embodiment, an interfering magnetic field stop instruction device 8221 instructs the interfering magnetic field controller 621 so that the interfering magnetic field generator 711 stops generating the interfering magnetic field.

Next, an operation mode of the card reader device A2 will be described. The description of the operation of the card reader device A2 from insertion of the magnetic card C into the insertion opening 100a to generation of the interfering magnetic field is similar to that of the first embodiment.

After the shutter 311 is closed and an interfering magnetic field is generated, when the magnetic card C reaches the reading position of the magnetic head 511, the magnetic data stored in the magnetic card C is read. In this operation mode, during reading of the magnetic data, the interfering magnetic field generated from the interfering magnetic field generator 711 is temporarily stopped. Specifically, for example, when the magnetic card position detecting unit 821 detects the magnetic card C is at the reading position, the interfering magnetic field stop instruction unit 822 outputs an interfering magnetic field stop signal to the interfering magnetic field control unit 62. In response to this stop signal, the interfering magnetic field control unit 62 temporarily stops generation of the interfering magnetic field by the interfering magnetic field generator 711.

Subsequently, the magnetic head 511 reads the magnetic data of the magnetic card C. In this case, sine generation of an interfering magnetic field is stopped temporarily, by allowing the magnetic head 511 to read the magnetic data in this stopping period, the magnetic head 511 can read correct magnetic data without being influenced by the interfering magnetic field. After the stopping period ends, the interfering magnetic field generator 711 generates an interfering magnetic field again to prevent the skimmer S from reading the magnetic data.

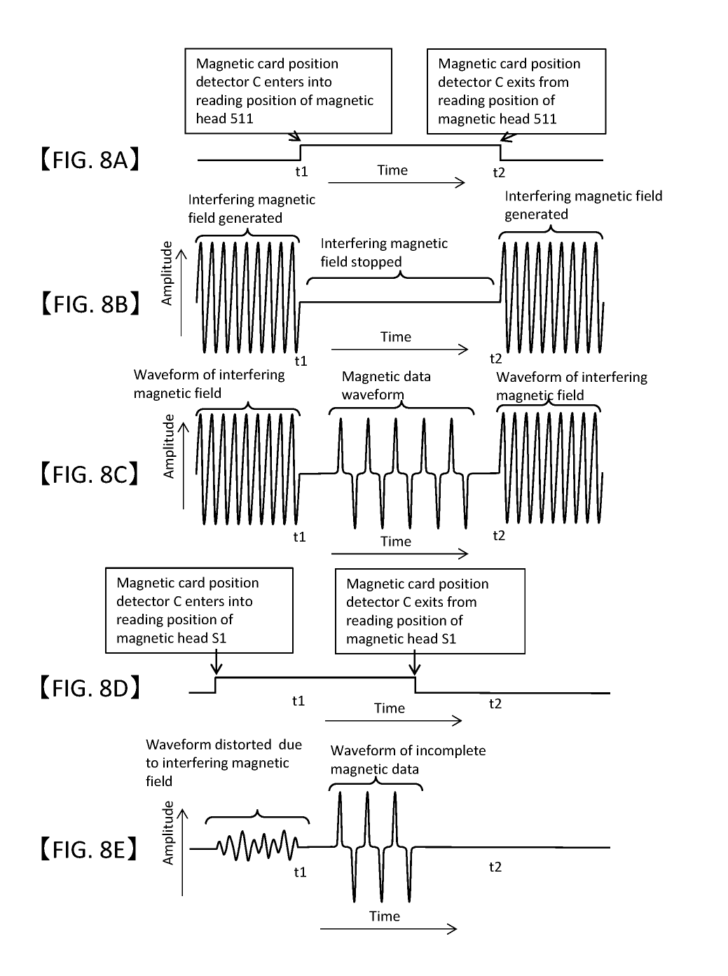

Here, an example of a waveform to be read will be described. FIGS. 8A to 8E are schematic diagrams illustrating timings and waveforms of the second embodiment. This diagram illustrates a relation between the timing at which generation of an interfering magnetic field is stopped temporarily and a waveform that the magnetic head 511 reads. The horizontal axis in FIGS. 8A to 8E represents a time axis and the timings (the position on the horizontal axis) of FIGS. 8A to 8E correspond to each other. For example, FIG. 8A illustrates a detection timing of the magnetic card C by the magnetic card position detector 8211. That is, a timing at which the magnetic head 511 reads the magnetic data is illustrated. Time t1 indicates a reading starting timing and time t2 indicates a reading ending timing. Generation of an interfering magnetic field is temporarily stopped in a period between time t1 and time t2 (see FIG. 8B), and the magnetic data of the magnetic card C is read correctly by the magnetic head 511 in this stopping period (see FIG. 8C). On the other hand, a timing at which the magnetic card C passes through a reading position of the magnetic head S1 of the skimmer S is different from the reading timing of the magnetic head 511 (see FIG. 8D), and the waveform read by the magnetic head S1 is a waveform which is at least partially influenced by an interfering magnetic field (waveform disturbed by the interfering magnetic field) (see FIG. 8E). Due to this, the waveform read by the magnetic head S1 is incomplete and reading of correct magnetic data is interfered.

Since the card reader device A2 has the above-described configuration, by temporarily stopping generation of an interfering magnetic field by the interfering magnetic field generator 711 while the magnetic data is being read by the magnetic head 511, it is possible to read correct magnetic data reliably without being influenced by the interfering magnetic field.

### Third Embodiment

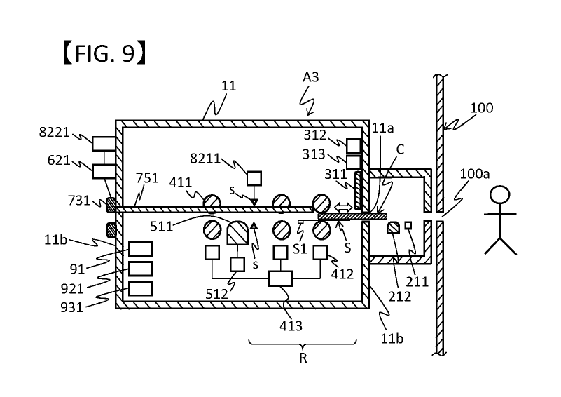

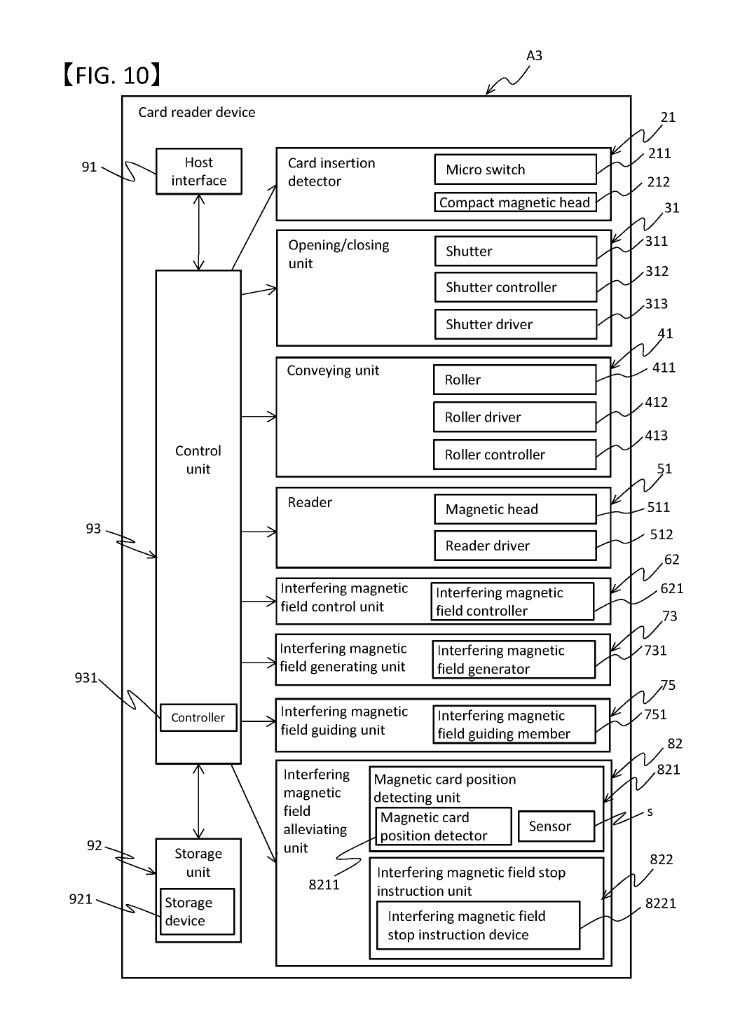

FIG. 9 is a schematic cross-sectional view illustrating a third embodiment of the present invention. FIG. 10 is a schematic block diagram of FIG. 9. As illustrated in FIGS. 9 and 10, a card reader device A3 schematically includes a housing 11, a card insertion detector 21, an opening/closing unit 31, a conveying unit 41, a reader 51, an interfering magnetic field control unit 62, an interfering magnetic field generating unit 73, an interfering magnetic field guiding unit 75, an interfering magnetic field alleviating unit 82, a host interface 91, a storage unit 92, and a control unit 93. The card reader device A3 is different from that of the second embodiment in that the interfering magnetic field generating unit 73 and the interfering magnetic field guiding unit 75 are different from those of the second embodiment. The other configuration is similar to that of the second embodiment, and the same portions will be denoted by the same reference numerals and the detailed description thereof will be omitted. An operation mode of the card reader device A3 is similar to that of the second embodiment, and the description thereof is similar to that of the second embodiment.

The interfering magnetic field generating unit 73 generates an interfering magnetic field at least in a region R between the magnetic head 511 and the shutter 311. Specifically, the interfering magnetic field generating unit 73 includes an interfering magnetic field generator 731 and a driving circuit for driving the interfering magnetic field generator 731, for example. The interfering magnetic field generator 731 is disposed on the rear surface side of the shutter 311 and outside the housing 11. In the present embodiment, a coil antenna is used as the interfering magnetic field generator 731, and the coil antenna is attached to the outer surface of the wall 11b of the housing 11 on the opposite side to the shutter 311 across the magnetic head 511 of the housing 11 to generate an interfering magnetic field in the region R through the wall 11b.

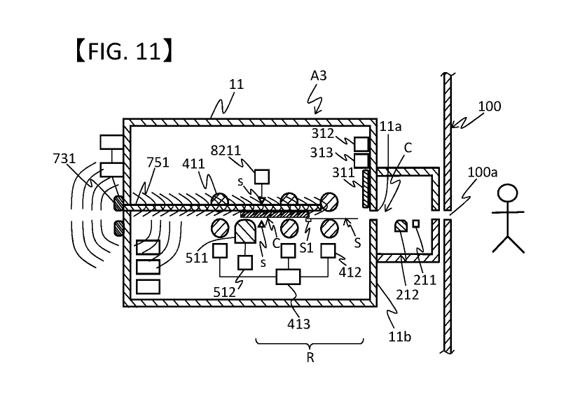

The interfering magnetic field guiding unit 75 guides the interfering magnetic field generated by the interfering magnetic field generator 731 at least to the region R between the magnetic head 511 and the shutter 311 (see FIG. 11). The interfering magnetic field guiding unit 75 may be configured as an elongated interfering magnetic field guiding member 751 formed of a magnetic material, extending from a portion to which the coil antenna is attached to the region R, for example. The interfering magnetic field guiding member 751 preferably has an elongated shape along a conveying path of the magnetic card C since the skimmer S is provided along the conveying path. Materials similar to that exemplified as a material that forms the interfering magnetic field shielding member 811 can be used as the magnetic material.

As described above, in the card reader device A3, since the interfering magnetic field generator 731 is disposed outside the housing 11, it is possible to form the card reader device A3 regardless of the size of the interfering magnetic field generator 731. Since the card reader device A3 guides the interfering magnetic field generated by the interfering magnetic field generator 731 at least to the region R between the magnetic head 511 and the shutter 311, the interfering magnetic field has directivity. Moreover, it is possible to generate an interfering magnetic field effectively in the region R in such a way that a large electric power input when the distance between the interfering magnetic field generator 731 and the region R is large (an electric power necessary for generating a strong interfering magnetic field) can be reduced.

The present invention is not limited to the configuration of the above-described embodiments. The scope of the present invention is defined by the attached claims and is intended to include all modifications made within the meaning and the range of equivalency of the claims.

For example, in the first and second embodiments described above, the card reader devices A1 and A2 in which the interfering magnetic field generator 711 is disposed between the magnetic head 511 and the shutter 311 have been described. However, the interfering magnetic field generator may be disposed in any position on the rear surface side of the shutter unless the advantages of the present invention are not impaired.

In the third embodiment described above, the card reader device A3 including both the interfering magnetic field generator 731 and the interfering magnetic field guiding member 751 has been described. However, the card reader device may not include either the interfering magnetic field generator or the interfering magnetic field guiding member and may include only one of them.

1. A card reader device comprising:
a housing;
an openable shutter provided in the housing to allow or disallow passing of a magnetic card into the housing;
a magnetic head provided in the housing to read magnetic data of the magnetic card received in the housing;
an interfering magnetic field generator provided on a rear surface side of the shutter to generate an interfering magnetic field in at least a region between the magnetic head and the shutter;
an interfering magnetic field control unit that controls generation of the interfering magnetic field by the interfering magnetic field generator; and
an interfering magnetic field alleviating unit that alleviates an influence of the interfering magnetic field on the magnetic head so that the interfering magnetic field generated by the interfering magnetic field generator does not interfere the reading of the magnetic data by the magnetic head.

2. The card reader device according to claim 1, wherein
the interfering magnetic field alleviating unit is an interfering magnetic field shielding member disposed between the interfering magnetic field generator and the magnetic head to shield the interfering magnetic field.

3. The card reader device according to claim 1, wherein
the interfering magnetic field alleviating unit includes:
a magnetic card position detecting unit that detects whether the magnetic card is at a position at which the magnetic data is read by the magnetic head; and
an interfering magnetic field stop instruction unit that instructs the interfering magnetic field control unit so that the interfering magnetic field generator stops generating the interfering magnetic field when the magnetic card position detecting unit has detected that the magnetic card is at the position at which the magnetic data is read.

4. The card reader device according to claim 1, wherein
the interfering magnetic field generator is disposed in the housing.

5. The card reader device according to claim 1, wherein
the interfering magnetic field generator is disposed outside the housing.

6. The card reader device according to claim 1, further comprising:
an interfering magnetic field guiding unit that guides the interfering magnetic field generated by the interfering magnetic field generator to at least a region between the magnetic head and the shutter.

7. The card reader device according claim 1, wherein
the interfering magnetic field generator generates an interfering magnetic field that simulates the magnetic data of the magnetic card.
